(19) United States
(12) Patent Application Publication
(10) Pub. No.: US 2008/0266861 A1
(43) Pub. Date: Oct. 30, 2008

(54) Low-Pressure Discharge Lamp Having Improved Efficiency

(75) Inventors: Thomas Justel, Witten (DE); Jacqueline Merikhi, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics , N.V., Eindhoven (NL)

(21) Appl. No.: 12/097,119

(22) PCT Filed: Dec. 4, 2006
(86) PCT No.: PCT/IB06/54575

§ 371 Date: Jun. 12, 2008

(30) Foreign Application Priority Data
Dec. 16, 2005 (EP) 05112313.1

(51) Int. Cl. F21K 2/00; H01J 61/35

(52) U.S. Cl. 362/263; 313/642

(57) ABSTRACT

The invention relates to a low-pressure mercury vapor discharge lamp (10) comprising a light-transmitting discharge vessel (12) having a first layer (20) and a second layer (22), the first layer (20) facing the discharge space (14) and the second layer (22) being arranged between the first layer (20) and an inner wall (18) of the discharge vessel (12). The first layer (20) comprising a first luminescent material for converting ultraviolet light (24) into output light (26). The second layer (22) comprising a second luminescent material for converting at least part of the ultraviolet light (26) transmitted through the first layer (20) into recycled ultraviolet light (28). The effect of the measures according to the invention is that at least part of the ultraviolet light (24) which is transmitted through the first layer (20) is converted by the second luminescent material of the second layer (22) into recycled ultraviolet light (28) which can subsequently be converted by the first luminescent material into output light (26), increasing the efficiency of the low-pressure mercury vapor discharge lamp (10). In a preferred embodiment of the low-pressure mercury vapor discharge lamp (40), the low-pressure mercury vapor discharge lamp (40) comprises a third layer (42) arranged between the discharge and the first layer (20) for converting ultraviolet light (24) into protective ultraviolet light (44) for protecting the first layer (20) from direct incidence of the ultraviolet light (24).

The invention relates to a low-pressure mercury vapor discharge lamp comprising a first luminescent material for converting ultraviolet light into output light being light emitted by the low-pressure mercury vapor discharge lamp.

In low-pressure mercury vapor discharge lamps, mercury constitutes the primary component for the (efficient) generation of ultraviolet (further also referred to as UV) light. A luminescent layer comprising a luminescent material may be present on an inner wall of a discharge vessel to convert UV to other wavelengths, for example, to UV-C for medical purposes, to UV-B and UV-A for tanning purposes (sun tanning lamps) or to visible radiation for general illumination purposes. Such discharge lamps are therefore also referred to as fluorescent lamps. Fluorescent lamps for general illumination purposes usually comprise a mixture of three luminescent materials, for example, a blue-luminescent europium-activated barium magnesium aluminate, BaMgAl₁₀O₁₇:Eu²⁺ (also referred to as BAM), a green-luminescent cerium-terbium co-activated lanthanum phosphate, LaPO₄:Ce,Tb (also referred to as LAP) and a red luminescent europium-activated yttrium oxide, Y₂O₃:Eu (also referred to as YOX).

The discharge vessel of low-pressure mercury vapor discharge lamps is usually constituted by a light-transmitting envelope enclosing a discharge space in a gastight manner. The discharge vessel is generally circular and comprises both elongate and compact embodiments. Normally, the means for maintaining a discharge in the discharge space are electrodes arranged in the discharge space. Alternatively, the low-pressure mercury vapor discharge lamp is a so-called electrodeless low-pressure mercury vapor discharge lamp.

U.S. Pat. No. 4,544,997 relates to a low-pressure mercury vapor discharge lamp having a transparent layer between the luminescent layer and the inner wall of the discharge vessel. The transparent layer is constituted of an oxide consisting of oxygen and at least one of the elements selected from the group consisting of yttrium, scandium, lanthanum, gadolinium, ytterbium and lutetium. The transparent layer protects the wall of the vessel, generally glass, from the influence of the discharge. Using the disclosed transparent layer reduces graying and discoloring of the glass wall of the discharge vessel.

A drawback of the known low-pressure mercury vapor discharge lamps is that luminescent conversion efficiency is not optimal.

It is an object of the invention to provide a low-pressure mercury vapor discharge lamp with improved luminescent conversion efficiency.

According to a first aspect of the invention the object is achieved with a low-pressure mercury vapor discharge lamp comprising a light-transmitting discharge vessel enclosing, in a gastight manner, a discharge space provided with a filling of mercury and a rare gas, the discharge vessel comprising discharge means for maintaining a discharge in the discharge space emitting ultraviolet light, an inner wall of the discharge vessel being provided with a first layer and a second layer, the first layer facing the discharge space and the second layer being arranged between the first layer and the inner wall of the discharge vessel, the first layer comprising a first luminescent material for converting ultraviolet light into output light being light emitted by the low-pressure mercury vapor discharge lamp, the second layer comprising a second luminescent material for converting at least part of the ultraviolet light transmitted through the first layer into recycled ultraviolet light having an increased wavelength with respect to the ultraviolet light, at least part of the recycled ultraviolet light being converted by the first luminescent material of the first layer into output light.

The effect of the measures according to the invention is that at least part of the ultraviolet light emitted by the discharge of the low-pressure mercury vapor discharge lamp and transmitted through the first layer is absorbed by the second luminescent material of the second layer and converted into recycled ultraviolet light which is emitted by the second layer. Part of this recycled ultraviolet light is subsequently absorbed by the first luminescent material of the first layer and converted into output light. Due to the emission of the recycled ultraviolet light by the second layer and the conversion of at least part of the recycled ultraviolet light into output light, the luminance conversion efficiency of the low-pressure mercury vapor discharge lamp according to the invention is increased.

The inventor has realized that in known low-pressure mercury vapor discharge lamps part of the ultraviolet light emitted by the discharge is lost. The lost ultraviolet light is not converted into output light by the luminescent material, but is transmitted through the luminescent material and either reabsorbed by the low-pressure mercury vapor discharge lamp or absorbed by the wall of the discharge vessel. The low-pressure mercury vapor discharge lamp according to the invention comprises a second layer comprising a second luminescent material which absorbs at least part of the ultraviolet light transmitted through the first layer and converts the absorbed ultraviolet light into recycled ultraviolet light. The recycled ultraviolet light will be emitted by the second layer substantially in all directions and at least part of the emitted recycled ultraviolet light will impinge on the first layer. The first luminescent material of the first layer will subsequently convert the recycled ultraviolet light into output light.

Throughout this document the term recycled ultraviolet light is used for ultraviolet light which is transmitted by the first layer and absorbed and subsequently emitted by the second luminescent material of the second layer. The second luminescent material of the second layer “recycles” at least part of the ultraviolet light transmitted by the first layer by converting it into recycled ultraviolet light which has an increased wavelength with respect to ultraviolet light absorbed by the second layer. The term “recycling” is employed to indicate that light which is transmitted by the first layer is used again (recycled) via absorption in the second layer and subsequently emission as recycled ultraviolet light. Part of the emitted recycled ultraviolet light impinges on the first layer and subsequently is converted by the first luminescent material into output light emitted by the low-pressure mercury vapor discharge lamp. The recycled ultraviolet light is emitted by the second layer in substantially all directions. In known low-pressure mercury vapor discharge lamps the ultraviolet light which is transmitted by the first layer is typically lost, either via absorption in the discharge vessel or via emission by the low-pressure mercury vapor discharge lamp.

In an embodiment of the low-pressure mercury vapor discharge lamp, the second layer is further arranged for reflecting at least part of the ultraviolet light transmitted through the first layer back into the first layer. A benefit of this embodiment is that next to the emission of the recycled ultraviolet light, the second layer reflects at least part of the ultraviolet light transmitted through the first layer to further increase the efficiency of the low-pressure mercury vapor discharge lamp.

In an embodiment of the low-pressure mercury vapor discharge lamp, the second luminescent material comprises lanthanide orthophosphate LnPO₄:M, Ln being selected from a group comprising Yttrium, Lanthanum, Gadolinium and Lutetium, and M being selected from a group comprising Gadolinium³⁺, Neodynium³⁺, Praseodymium³⁺, Cerium³⁺ and Bismuth³⁺. A benefit of this embodiment is that ultraviolet light from the discharge transmitted through the first luminescent layer is converted into ultraviolet UV-C-light in the second luminescent layer, which is reemitted by the second luminescent layer. Part of the reemitted UV-C light will impinge on the first luminescent layer, where it has a second chance to be converted into visible light.

In an embodiment of the low-pressure mercury vapor discharge lamp, the second layer is constituted of nanoscale particles having an average particle size ranging from 2 nanometer to 100 nanometer. A benefit of this embodiment is that the nanoscale particles constitute a large scatter surface enabling effective reflection of ultraviolet light. A further benefit of this embodiment is that the layer of nanoscale particles can effectively be used as protection surface of the discharge vessel from the influence of the discharge. Furthermore, the use of nanoscale particles improves the adhesion of the second layer to the inner wall of the discharge vessel and improves the adhesion of the first layer to the second layer.

In an embodiment of the low-pressure mercury vapor discharge lamp, the output light of the first luminescent material comprises: ultraviolet-C light, having a wavelength between 100 nanometer and 290 nanometer, ultraviolet-B light, having a wavelength between 290 nanometer and 320 nanometer, or ultraviolet-A light, having a wavelength between 320 nanometer and 400 nanometer. A benefit of this embodiment is that the low-pressure mercury vapor discharge lamp having improved efficiency also beneficially can be used for medical, germicidal, and tanning purposed low-pressure mercury vapor discharge lamps. To enable the emission of the ultraviolet-C light, the ultraviolet-B light or the ultraviolet-A light, the discharge vessel generally is constituted of quartz.

In an embodiment of the low-pressure mercury vapor discharge lamp, the first layer is constituted of a mix of three different luminescent materials, each one of the three different luminescent materials contributing a primary color to the output light. A benefit of this embodiment is that the low-pressure mercury vapor discharge lamp is able to provide visible radiation for general illumination purposes.

In an embodiment of the low-pressure mercury vapor discharge lamp, a third layer is arranged between the first layer and the discharge space, the third layer comprising a third luminescent material for converting ultraviolet light into protective ultraviolet light having an increased wavelength with respect to the ultraviolet light. A benefit of this embodiment is that the third layer protects the first layer from direct impinging of ultraviolet light emitted by the discharge. In the known low-pressure mercury vapor discharge lamps ultraviolet light having a relatively short wavelength (around and below 200 nanometer) usually causes the quantum efficiency of the luminescent material to be reduced over time. In the low-pressure mercury vapor discharge lamp according to the invention the ultraviolet light emitted by the discharge is converted into protective ultraviolet light having an increased wavelength with respect to the ultraviolet light emitted by the discharge, the first luminescent material is protected from direct impinging of ultraviolet light emitted by the discharge which limits the reduction of quantum efficiency of the luminescent material over time.

In an embodiment of the low-pressure mercury vapor discharge lamp, the second luminescent material is constituted of cerium doped yttrium orthophosphate YPO₄:Ce and the third luminescent material is constituted of praseodymium doped yttrium orthophosphate YPO₄:Pr. A benefit of this embodiment is that the third luminescent material converts ultraviolet light from the discharge into protective ultraviolet light which subsequently can be converted by the second luminescent material into recycled ultraviolet light. Because the praseodymium doped yttrium orthophosphate YPO₄:Pr has an emission spectrum with a maximum at approximately 250 nanometer (being the protective ultraviolet light) the light emitted by the praseodymium doped yttrium orthophosphate YPO₄:Pr can be absorbed by the cerium doped yttrium orthophosphate YPO₄:Ce which has an absorption spectrum with a maximum at approximately 260 nanometer. The subsequently emitted recycled ultraviolet light by the cerium doped yttrium orthophosphate YPO₄:Ce has an emission spectrum with a maximum at approximately 350 nanometer.

The invention also relates to the use of the low-pressure mercury vapor discharge lamp according to the invention for diagnostic or therapeutic devices, and for germicidal or cosmetic devices. The diagnostic devices, for example, comprise medical imaging and the therapeutic devices, for example, comprise a radiotherapy apparatus for the treatment of psoriasis. The cosmetic device, for example, comprises a tanning lamp. Further, the invention also relates to the use for a germicidal device for affecting on germs or pathogens for sanitary purposes to make the germs or pathogens innocuous or kill the germs or pathogens, respectively.

The invention moreover relates to a medical device comprising a low-pressure mercury vapor discharge lamp as claimed in claim 1. The medical device can be a germicidal device, a cosmetic device, a tanning lamp or another device comprising the inventory discharge lamp.

These and other aspects of the invention are apparent from and will be elucidated with reference to the embodiments described hereinafter.

### BRIEF DESCRIPTION OF THE DRAWINGS

FIGS. 1A and 1B show a cross-section of a low-pressure mercury vapor discharge lamp according to the invention,

FIGS. 2A and 2B show a cross-section of a further low-pressure mercury vapor discharge lamp according to the invention, and

FIG. 3A shows the absorption and emission spectrum of praseodymium doped yttrium orthophosphate YPO₄:Pr and FIG. 3B shows the absorption and emission spectrum of cerium doped yttrium orthophosphate YPO₄:Ce.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE DRAWINGS

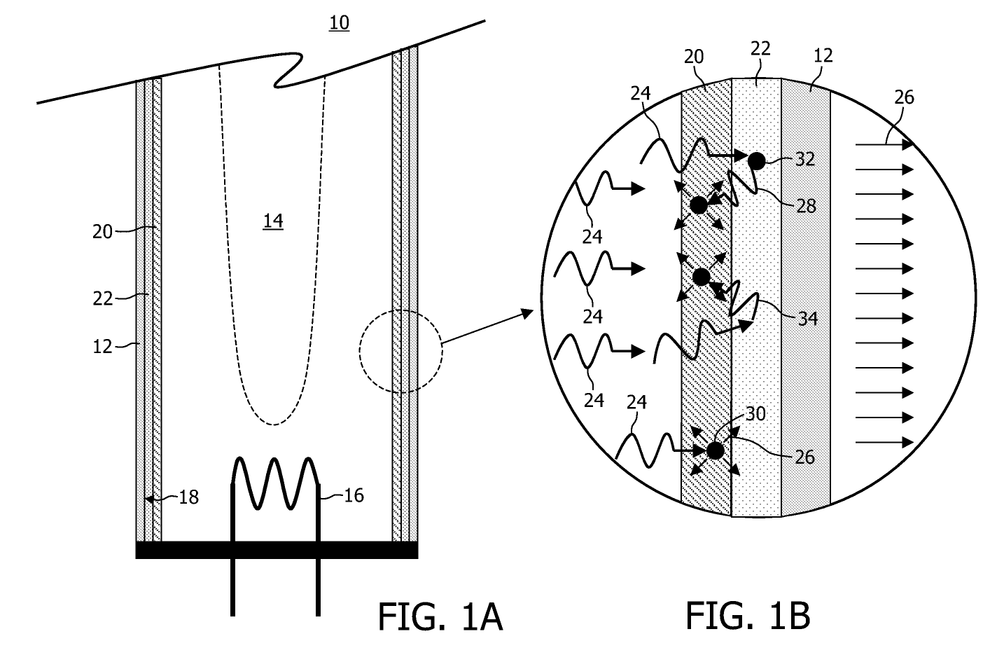

FIG. 1A shows a cross-section of a low-pressure mercury vapor discharge lamp 10 according to the invention. FIG. 1B shows an enlarged detail of a wall section of the low-pressure mercury vapor discharge lamp 10 of FIG. 1A. In the embodiment shown, the low-pressure mercury vapor discharge lamp 10 comprises a discharge vessel 12 which encloses a discharge space 14 in a gastight manner. Discharge vessels 12 of low-pressure mercury vapor discharge lamps 10, 40 usually are circular and comprise both elongate and compact embodiments. The discharge vessel 12 is provided with a filling of mercury vapor and a rare gas and further comprises a set of electrodes 16 (only one of the two electrodes 16 is shown in FIG. 1A). The electrodes 16 constitute the discharge means 16 of the low-pressure mercury vapor discharge lamp 10 for initiating and maintaining a discharge within the discharge space 14 of the discharge vessel 12. In operation, an electric circuitry (not shown) provides a discharge current through the low-pressure mercury vapor discharge lamp 10, which excites the ionized mercury vapor in the discharge space 14. The ionized mercury vapor subsequently emits ultraviolet light 24.

An inner wall 18 of the discharge vessel 10 comprises a first layer 20 and a second layer 22. The first layer 20 faces the discharge space 14 and the second layer 22 is arranged between the first layer 20 and the inner wall 18 of the discharge vessel 12. The first layer 20 comprises a first luminescent material, which converts ultraviolet light 24 (see details in FIG. 1B) emitted from the discharge space 14 into output light 26 of the low-pressure mercury vapor discharge lamp 10. The choice of the first luminescent material usually determines a color of the output light 26.

The second layer 22 comprises a second luminescent material. The second luminescent material converts ultraviolet light 24 emitted from the discharge space 14 and transmitted through the first layer 20 into recycled ultraviolet light 28 and reemits the recycled ultraviolet light 28 substantially in all directions. Part of the reemitted recycled ultraviolet light 28 is directed toward the first layer 20 and impinges on the first luminescent material of the first layer 20. The first luminescent materially is chosen such that the recycled ultraviolet light 28 is absorbed by the first luminescent material and subsequently converted into output light 26 of the low-pressure mercury vapor discharge lamp 10, 40. The recycled ultraviolet light 28 usually has an increased wavelength with respect to the ultraviolet light 24 emitted by the mercury vapor of the discharge space 14. In known low-pressure mercury vapor discharge lamps the ultraviolet light 24 transmitted through the first layer 20 typically is lost and is either absorbed in the wall 18 of the discharge vessel 12 or is emitted from the low-pressure mercury vapor discharge lamp. In contrast, in the low-pressure mercury vapor discharge lamp 10, 40 according to the invention at least part of the transmitted ultraviolet light 24 is reemitted by the second luminescent material of the second layer 22 as recycled ultraviolet light 28. Subsequently, at least part of the reemitted recycled ultraviolet light 28 is converted into output light 26 of the low-pressure mercury vapor discharge lamp 10, 40 by the first luminescent material of the first layer 20. Due to the conversion of the transmitted ultraviolet light 24 via recycled ultraviolet light 28 into output light 26, the efficiency of the low-pressure mercury vapor discharge lamp 10, 40 is increased.

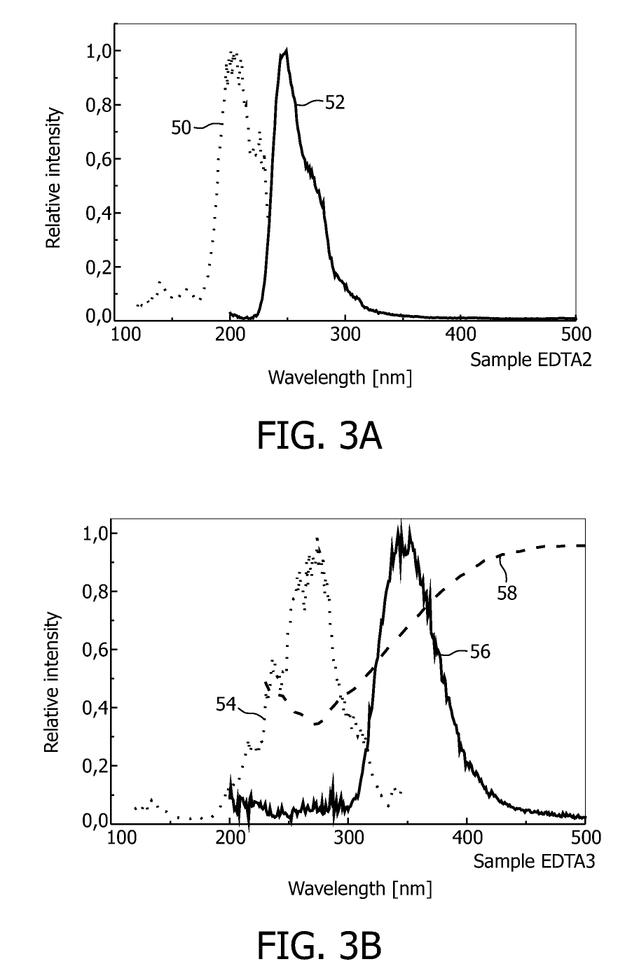

In an embodiment of the low-pressure mercury vapor discharge lamp 10, 40, the second luminescent material comprises lanthanide orthophosphate (LnPO₄:M). Lanthanide (Ln) being one out of a group comprising Yttrium, Lanthanum, Gadolinium and Lutetium. The lanthanide orthophosphate being doped with one out of a group comprising Gadolinium³⁺, Neodynium³⁺, Praseodymium³⁺, Cerium³⁺ and Bismuth³⁺ represented in the formula with the letter M. These lanthanide orthophosphates (LnPO₄:M) absorb ultraviolet light and emit ultraviolet light having an increased wavelength with respect to the absorbed ultraviolet light. When applied in a low-pressure mercury vapor discharge lamp 10, 40 according to the invention, the lanthanide orthophosphates (LnPO₄:M) absorb transmitted ultraviolet light 24 and reemit the recycled ultraviolet light 28 and as such contribute to the increased efficiency of the low-pressure mercury vapor discharge lamp 10, 40. In table 1 a listing of the possible compositions of the lanthanide orthophosphates (LnPO₄:M) is provided together with the emission maximum of the lanthanide orthophosphate (LnPO₄:M). As an example, FIG. 3A shows the absorption 50 and emission 52 spectrum of cerium doped yttrium orthophosphate (YPO₄:Ce) and FIG. 3B shows the absorption 54 and emission 56 spectrum of praseodymium doped yttrium orthophosphate (YPO₄:Pr).

TABLE 1
listing of the possible compositions of the lanthanide orthophosphates.

| lanthanide orthophosphate (LnPO₄:M) | Emission maximum [nanometer] |
|---|---|
| YPO₄:Ce | 345 |
| LaPO₄:Ce | 320 |
| GdPO₄:Ce | 311, 345 |
| (Y₁₋ₓGdₓ)PO₄:Ce | 345 |
| LuPO₄:Ce | 340 |
| YPO₄:Pr | 235 |
| LaPO₄:Pr | 240 |
| GdPO₄:Pr | 235, 311 |
| LuPO₄:Pr | 235 |
| YPO₄:Nd | 190 |
| GdPO₄:Nd | 311 |
| YPO₄:Gd | 311 |
| LaPO₄:Gd | 311 |
| LuPO₄:Gd | 311 |

Lanthanide orthophosphate (LnPO₄:M) can, for example, be produced by a wet-chemical coating process using a controlled hydrolysis of coordination compounds of the respective lanthanide cations. In particular the application of ethylenediaminetetraacetate (further also referred to as EDTA) complexes is used, since this ligand forms rather stable coordination compounds with trivalent rare earth ions such as the lanthanide cations. A possible synthesis process providing nanoscale particles of lanthanide orthophosphate (LnPO₄) comprises, for example, the following steps:
preparation of a lanthanides EDTA-aquacomplex dissolved in water, ethanol or a blend thereof,
adding orthophosphate (H₂PO₄⁻) to form an [Ln(EDTA)(OH)(H₂PO₄)]⁻ complex,
adding sodium hydroxide (NaOH) to enhance a pH value of the solution to 9-10,
heating the solution to 50° C.-100° C. to form lanthanide orthophosphate (LnPO₄) seeds which grow to become lanthanide orthophosphate (LnPO₄) nanoscale particles,
drying the nanoscale particles at 70° C.-100° C. in a drying chamber, and
firing the dried nanopowder at temperatures between 200° C. and 600° C. for further crystallization of the material.

Instead of EDTA also, for example, deprotonated EDTA can be used. The described manufacturing process has the advantage that the synthesized layer of lanthanide orthophosphate (LnPO₄) is constituted of nanoscale particles having an average particle diameter typically between 2 nanometer and 100 nanometer. A benefit when using nanoscale particles in the second layer 22 is that nanoscale particles constitute a relatively large scatter surface providing effective reflection of transmitted ultraviolet light 24 back into the first layer 20. A further benefit when using a second layer 22 constituted of nanoscale particles is that the second layer 22 can effectively be used as protection layer for the discharge vessel 12, protecting the discharge vessel 12 from the influence of the discharge. In addition, the use of the second layer 22 constituted of nanoscale particles improves the adhesion of the second layer 22 to the inner wall 18 of the discharge vessel 12 and improves the adhesion of the first layer 20 to the second layer 22.

The first luminescent material of the first layer 20 converts the ultraviolet light 24 emitted from the discharge space 14 into output light 26 of the low-pressure mercury vapor discharge lamp 10. The choice of the first luminescent material usually determines a characteristic of the output light 26. For example, in low-pressure mercury vapor discharge lamps 10, 40 which provide output light 26 for general illumination purposes, the first luminescent material in the first layer 20 usually comprise a mixture of three luminescent materials, for example, a blue-luminescent europium-activated barium magnesium aluminate, BaMgAl₁₀O₁₇:Eu²⁺ (also referred to as BAM), a green-luminescent cerium-terbium co-activated lanthanum phosphate, LaPO₄:Ce,Tb (also referred to as LAP) and a red luminescent europium-activated yttrium oxide, Y₂O₃:Eu (also referred to as YOX). Mixing these three luminescent materials in different weight percentages will result in low-pressure mercury vapor discharge lamps 10, 40 emitting output light 26 of a different color. In another embodiment of the low-pressure mercury vapor discharge lamp 10, 40, the output light 26 of the first luminescent material comprises, for example, ultraviolet-C light, having a wavelength between 100 nanometer and 290 nanometer, ultraviolet-B light, having a wavelength between 290 nanometer and 320 nanometer, or ultraviolet-A light, having a wavelength between 320 nanometer and 400 nanometer. Low-pressure mercury vapor discharge lamps 10, 40 emitting ultraviolet-C light, ultraviolet-B light or ultraviolet-A light, or a combination of the three are typically used for medical, germicidal, and cosmetic purposes. An example of a medical use is the treatment of psoriasis in a radiation therapy using the low-pressure mercury vapor discharge lamps 10, 40 according to the invention. An example of a cosmetic use is the use of the low-pressure mercury vapor discharge lamp according to the invention for tanning purposes. To enable the emission of the ultraviolet-C light, the ultraviolet-B light and/or the ultraviolet-A light the discharge vessel 12 generally is constituted of quartz.

FIG. 1B illustrates the absorption and subsequent conversion of light in the first layer 20 and the second layer 22. The absorption of ultraviolet light 24 emitted from the discharge space 14 is absorbed by the first luminescent material in the first layer 20, which is indicated in FIG. 1B with a point having reference number 30. The first luminescent material subsequently converts the absorbed ultraviolet light 24 into output light 26 and emits the output light 26 substantially in all directions, indicated in FIG. 1B with the arrows originating from the point 30. However, some of the ultraviolet light 24 will be transmit through the first layer 20 without being converted into output light 26. A part of the ultraviolet light 24 transmitted through the first layer 20 is reflected by the second layer 22 back into the first layer 20, which is indicated in FIG. 1B with the arrow having reference number 34. This reflected ultraviolet light 34 may subsequently be converted into output light 26 by the first luminescent material. Another part of the ultraviolet light 24 transmitted through the first layer 20 may be absorbed by the second luminescent material in the second layer 22, as indicated with the point having reference number 32. The second luminescent material subsequently converts the absorbed ultraviolet light 24 into recycled ultraviolet light 28, indicated by the arrow having reference number 28. Typically the emission of the recycled ultraviolet light 28 by the second layer 22 will be in all directions. The recycled ultraviolet light 28 which impinges on the first layer 20 may be converted into output light 26 by the first luminescent material and emitted from the low-pressure mercury vapor discharge lamp 10, 40. The remainder of the ultraviolet light 24 transmitted through the first layer 20 may be lost (not shown) and either absorbed by the discharge vessel 12 or emitted from the low-pressure mercury vapor discharge lamp 10, 40.

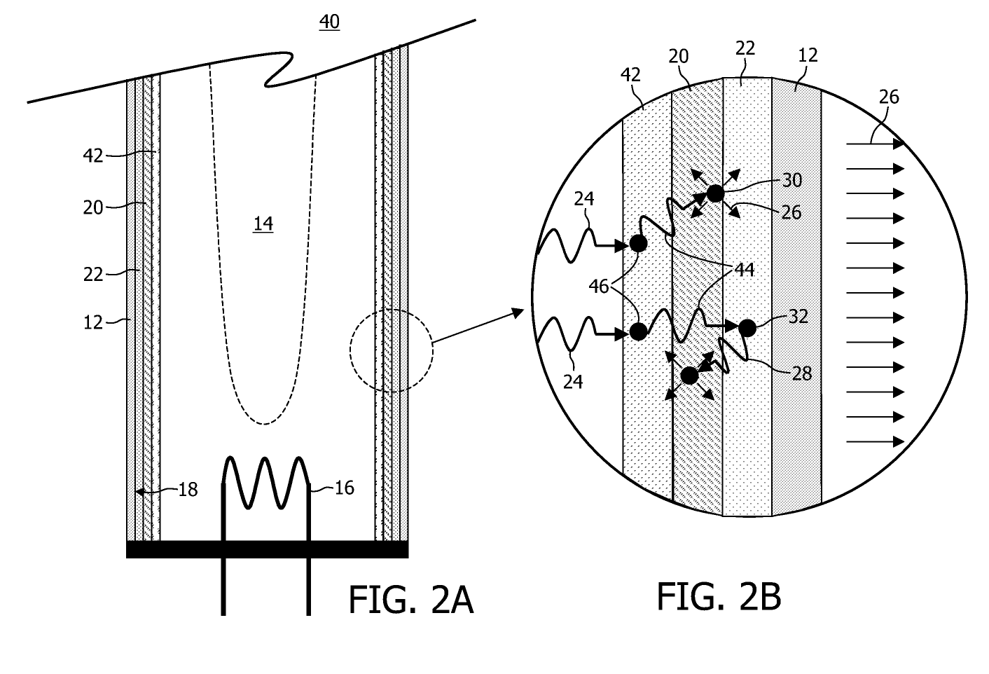

FIG. 2A shows a cross-section of a further low-pressure mercury vapor discharge lamp 40 according to the invention. FIG. 2B shows an enlarged detail of a wall section of the low-pressure mercury vapor discharge lamp 40 of FIG. 2A. In the low-pressure mercury vapor discharge lamp 40 shown in FIG. 2A an additional third layer 42 is applied between the discharge space 14 and the first layer 20. The third layer 42 comprises a third luminescent material for converting the ultraviolet light 24 emitted from the discharge space 14 into protective ultraviolet light 44 having an increased wavelength with respect to the ultraviolet light 24. The third layer 42 protects the first layer 20 from direct impinging of ultraviolet light 24 emitted from the discharge space 14 by converting the ultraviolet light 24 emitted from the discharge space 14 into protective ultraviolet light 44 having an increased wavelength with respect to the ultraviolet light 24. In known low-pressure mercury vapor discharge lamps the mercury vapor discharge emits ultraviolet light, which is absorbed by the luminescent material and converted into the output light, for example visible light. Especially the absorption of ultraviolet light having a relatively short wavelength (around and below 200 nanometer) causes the quantum efficiency of the luminescent material in the luminescent layer to be reduced over time. This results in a reduction of the efficiency of the luminescent material and often results in a shift of a color of the output light of the low-pressure mercury vapor discharge lamp. In the embodiment of the low-pressure mercury vapor discharge lamp 40 according to the invention the third layer 42 applied on top of the first layer 20 converts the ultraviolet light 24 into protective ultraviolet light 44 having an increased wavelength (typically well above 200 nanometer) with respect to the ultraviolet light 24. Due to the presence of the third layer 42 the first luminescent material of the first layer 20 absorbs the protective ultraviolet light 44 instead of the ultraviolet light 24 emitted from the discharges space 14, and converts the protective ultraviolet light 44 into output light 26. The addition of the third layer 42 reduces a decrease of the quantum efficiency of the first luminescent material and as such reduces a degradation of the first luminescent material over time, substantially maintaining the efficiency of the luminescent material.

In a preferred embodiment of the low-pressure mercury vapor discharge lamp 40 the third luminescent material of the third layer 42 and the second luminescent material in the second layer 22 are chosen such that the protective ultraviolet light 44 which transmits through the first layer can be absorbed by the second luminescent material in the second layer 22 and converted into recycled ultraviolet light 28. This is shown in FIG. 2B with a point having a reference number 32. By combining, for example, cerium doped yttrium orthophosphate (YPO₄:Ce) as second luminescent material and praseodymium doped yttrium orthophosphate (YPO₄:Pr) as third luminescent material the light emitted by the praseodymium doped yttrium orthophosphate (YPO₄:Pr) and transmitted through the first layer 20 may be converted into recycled ultraviolet light 28 by the cerium doped yttrium orthophosphate (YPO₄:Ce). The absorption 50 and emission 52 spectra of the praseodymium doped yttrium orthophosphate (YPO₄:Pr) are shown in FIG. 3A from which an emission maximum can be determined approximately between 230 nanometer and 260 nanometer. The absorption 54 and emission 56 spectra of the cerium doped yttrium orthophosphate (YPO₄:Ce) are shown in FIG. 3B from which an absorption maximum can be determined approximately between 250 nanometer and 280 nanometer. From the FIGS. 3A and 3B it can clearly be seen that ultraviolet light emitted by the praseodymium doped yttrium orthophosphate (YPO₄:Pr) can be absorbed by the cerium doped yttrium orthophosphate (YPO₄:Ce). A person skilled in the art can clearly choose different combinations of luminescent materials as second luminescent material and third luminescent material to obtain the absorption of light emitted from the third layer 42 by luminescent material of the second layer 22, for example, using a right combination of lanthanide orthophosphates (LnPO₄:M) listed in table 1.

FIG. 2B illustrates the absorption and subsequent conversion of light in the third layer and subsequent absorption and conversion in the first layer 20 and the second layer 22. Ultraviolet light 24 emitted from the discharge space 14 is absorbed by the third luminescent material in the third layer 42, which is indicated in FIG. 2B with a point having reference number 46. The third luminescent material subsequently converts the absorbed ultraviolet light 24 into protective ultraviolet light 44 and emits the protective ultraviolet light 44 substantially in all directions impinging on the first layer 20. The protective ultraviolet light 44 is absorbed by the first luminescent material of the first layer 20 and converted into output light 26. However, some of the protective ultraviolet light 42 will be transmit through the first layer 20 without being converted into output light 26. A part of the protective ultraviolet light 42 transmitted through the first layer 20 is reflected by the second layer 22 back into the first layer 20 (not shown). This reflected protective ultraviolet light may subsequently be converted into output light 26 by the first luminescent material. Another part of the protective ultraviolet light 42 transmitted through the first layer 20 may be absorbed by the second luminescent material in the second layer 22, as indicated with the point having reference number 32. The second luminescent material subsequently converts the absorbed protective ultraviolet light 42 into recycled ultraviolet light 28, indicated by the arrow having reference number 28. Typically the emission of the recycled ultraviolet light 28 by the second layer 22 will be in all directions. The recycled ultraviolet light 28 which impinges on the first layer 20 may be converted into output light 26 by the first luminescent material and emitted from the low-pressure mercury vapor discharge lamp 40. The remainder of the protective ultraviolet light 42 transmitted through the first layer 20 may be lost (not shown) and either absorbed by the discharge vessel 12 or emitted from the low-pressure mercury vapor discharge lamp 40.

An alternative embodiment of the discharge lamp 10, 40 in accordance with the invention comprises so-called electrodeless discharge lamps, in which the means for initiating and maintaining an electric discharge are situated outside a discharge space 14 surrounded by the discharge vessel 12. Generally said means are formed by a coil (not shown) being a winding of an electric conductor replacing electrodes 16. In operation, a high-frequency voltage, for example having a frequency of approximately 3 MHz, is supplied to said coil. In general, said coil surrounds a core of a soft-magnetic material.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp (10, 40) comprising:
a light-transmitting discharge vessel (12) enclosing, in a gastight manner, a discharge space (14) provided with a filling of mercury and a rare gas,
the discharge vessel (12) comprising discharge means (16) for maintaining a discharge in the discharge space (14) emitting ultraviolet light (24),
an inner wall (18) of the discharge vessel (12) being provided with a first layer (20) and a second layer (22), the first layer (20) facing the discharge space (14) and the second layer (22) being arranged between the first layer (20) and the inner wall (18) of the discharge vessel (12), the first layer (20) comprising a first luminescent material for converting ultraviolet light (24) into output light (26) being light emitted from the low-pressure mercury vapor discharge lamp (10, 40),
the second layer (22) comprising a second luminescent material for converting at least part of the ultraviolet light (24) transmitted through the first layer (20) into recycled ultraviolet light (28) having an increased wavelength with respect to the ultraviolet light (24), at least part of the recycled ultraviolet light (28) being converted by the first luminescent material of the first layer (20) into output light (26).

2. Low-pressure mercury vapor discharge lamp (10, 40) as claimed in claim 1, wherein the second layer (22) is further arranged for reflecting at least part of the ultraviolet light (24) transmitted through the first layer (20) back into the first layer (20).

3. Low-pressure mercury vapor discharge lamp (10, 40) as claimed in claim 1, wherein the second luminescent material comprises lanthanide orthophosphate LnPO₄:M, Ln being selected from a group comprising Yttrium, Lanthanum, Gadolinium and Lutetium, and M being selected from a group comprising Gadolinium^{3″1″}, Neodynium^{3″1″}, Praseodymium^{3″1″}, Cerium^{3″1″} and Bismuth^{3″1″}.

4. Low-pressure mercury vapor discharge lamp (10, 40) as claimed in claim 1, wherein the second layer (22) is constituted of nanoscale particles having an average particle size ranging from 2 nanometer to 100 nanometer.

5. Low-pressure mercury vapor discharge lamp (10, 40) as claimed in claim 1, wherein the output light (26) of the first luminescent material comprises:
ultra violet-C light, having a wavelength between 100 nanometer and 290 nanometer,
ultraviolet-B light, having a wavelength between 290 nanometer and 320 nanometer, or
ultraviolet-A light, having a wavelength between 320 nanometer and 400 nanometer.

6. Low-pressure mercury vapor discharge lamp (10, 40) as claimed in claim 1, wherein the first layer (20) is constituted of a mix of three different luminescent materials, each one of the three different luminescent materials contributing a primary color to the output light (26).

7. Low-pressure mercury vapor discharge lamp (10, 40) as claimed in claim 1, wherein a third layer (42) is arranged between the first layer (20) and the discharge space (14), the third layer (42) comprising a third luminescent material for converting ultraviolet light (24) into protective ultraviolet light (44) having an increased wavelength with respect to the ultraviolet light (24).

8. Low-pressure mercury vapor discharge lamp (10, 40) as claimed in claim 7, wherein the second luminescent material is constituted of cerium doped yttrium orthophosphate YPO₄:Ce and the third luminescent material is constituted of praseodymium doped yttrium orthophosphate YPO₄:Pr.

9. Low-pressure mercury vapor discharge lamp (10, 40) as claimed in claim 1, wherein the low-pressure mercury vapor discharge lamp is a diagnostic and/or therapeutic device.

10. Low-pressure mercury vapor discharge lamp (10, 40) as claimed in claim 9, wherein the diagnostic device comprises an apparatus designed for medical imaging and wherein the therapeutic device comprises a radiotherapy apparatus for the treatment of psoriasis.

11. Low-pressure mercury vapor discharge lamp (10, 40) as claimed in claim 1, the low pressure mercury vapor discharge lamp being incorporated into a cosmetic device selected from the group consisting of a tanning lamp and a germicidal device for making the germs or pathogens innocuous or killing the germs or pathogens.

12. Medical device comprising a low-pressure mercury vapor discharge lamp (10, 40) as claimed in claim 1.
